(19) United States
(12) Patent Application Publication
(10) Pub. No.: US 2012/0314083 A1
(43) Pub. Date: Dec. 13, 2012

(54) Handheld imaging and defense system

(76) Inventors: David E. Ratliff, Loganville, GA (US); Gregory S. Davis, Winder, GA (US)

(21) Appl. No.: 13/134,578

(22) Filed: Jun. 9, 2011

(51) Int. Cl. H04N 5/33

(52) U.S. Cl. 348/164; 348/E05.09

(57) ABSTRACT

This invention provides a handheld imaging system for use by law enforcement that has an infrared camera disposed at a lower portion of a housing and a display on an upper portion of the housing. A color CCD camera is also provided for surveillance situations that are not in low light. The imaging system contains tactical flashlights that operate in a programmable multimode fashion. Images captured by the handheld imaging system may be transmitted wirelessly to a remote location or stored in a memory contained within the housing. Finally, a series of detachable accessories are provided that may include a siren, taser or a pepper spray device.

### 1. FIELD OF THE INVENTION

This invention relates to a handheld imaging and defense system. More particularly, the present invention relates to a handheld system containing thermal imaging and defensive mechanisms that result in increased safety for users.

### 2. BACKGROUND OF THE INVENTION

Law enforcement personnel often rely on their senses when performing their jobs. They are often required to search and find suspects in total and complete darkness. For example, traditional search and pursuit techniques require the law enforcement personnel to enter areas using a flashlight to illuminate the area or use available ambient light from other surrounding sources. This presents difficult and often dangerous conditions because these traditional sources can only illuminate areas that are directly in a line of sight from that source. Because safety is one of the primary concerns, the use of video surveillance equipment has increased by law enforcement personnel, giving the personnel the ability to see the suspect and the surrounding area without putting themselves in harms way. Accordingly, there is a need for a surveillance device that can be used by the officer without having to place themselves in harm.

Due to instances where a record of an arrest or traffic stop is necessary, many law enforcement vehicles use video surveillance equipment to record the situation and provide officials with a video record for training purposes and evidence in any legal proceedings subsequent to the stop. However, these surveillance methods are not portable and not usable in situations where the suspect may flee the scene into an area that is out of reach of the equipment. Accordingly, there is a need for a portable system that is removable from the automobile.

Surveillance equipment, in conjunction with communications equipment, allows for better coordination between law enforcement and other personnel. This leads to better decision making between the personnel, which likely leads to increases in safety and decreases error. Law enforcement personnel also need multifunctional equipment that would serve multiple purposes to the official. This would increase cost effectiveness and would allows for the officer to ease their equipment burden in the field. As such, there is a need for equipment that is low cost and multifunctional.

While traditional video surveillance methods are useful, they are limited they can only view the surface of objects. In situations where areas are obstructed from the law enforcement by solid objects or other items, the law enforcement official may be forced to put him in a compromised position to adequately view and illuminate the area. This could potentially place the official out in the open and possibly in the way of a harmful situation. Scenarios such as these present difficult and often impossible scenarios for law enforcement to be successful in apprehending a fleeing suspect that as entered darkened areas while remaining safe.

Also, in situations where a fleeing suspect is known to be unarmed, pursuing law enforcement may need a non-deadly means to move to safety or to temporarily disable the suspect to apprehend them. Due to the nature of emergency situations, law enforcement may also need to have access to a non-deadly means to preserve evidence and capture the fleeing felon. Accordingly, an apparatus that is capable of temporarily disable a suspect is needed.

Similar situations are presented for rescuers where, during a search and rescue operations. The rescuer may be faced with looking for persons in deep forests, in dark structures or in areas where it is difficult for them to safely see and assess a situation before entering into it.

One primary type of surveillance device frequently utilized includes what is often referred to as “night vision”. Night vision type devices typically operate through the amplification or enhancement of the light visible by the device in a particular environment. Specifically, such devices will perceive the available light (typically light waves reflecting off of objects within the tactical field of view) and will significantly amplify the light to a point where they are effectively visible by a user of the device. As can be appreciated, however, because some illumination is necessary for light to be perceived by the night vision device, there are some tactical situations wherein such night vision devices are not practical or truly useful. One example of such an environment is a totally dark environment wherein no illumination or very little illumination is present, and therefore, an insufficient amplified image can be generated. In such circumstances, the night vision device is truly ineffective and the user is a left without any tactical advantage or ability to ascertain their surroundings. In addition to such low or no light tactical environments, such night vision devices often prove ineffective in overly illuminated tactical environments. For example, if excessive lighting is present, an overly amplified image that cannot be readily distinguished by the user may be generated by the night vision device.

Unlike video cameras, which can transform beams of visible light into electronic images, infrared imaging devices can make electronic images out of emissions of heat (beams of “thermal radiation”), which are invisible. Thermal-imaging devices such as infrared “cameras” can “see” and precisely measure differences in heat from a distance. It that way, infrared cameras are similar to video cameras, which are also long-range devices. But unlike video cameras, thermal-imaging devices can see through or render transparent all kinds of impediments, obstructions and barriers: airborne precipitation (rain, snow, fog); darkness (heavy cloud cover, night, power blackouts); liquids (oil, coolants, large bodies of water); and even solid objects (containers, buildings, the surface of the earth itself.

Accordingly, a device that can utilize the advantages of these technologies while overcoming the shortcomings of them is needed.

### SUMMARY OF INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

To resolve the problems mentioned above, an object of the present invention is to provide a handheld imaging and recording device that is readily accessible to a law enforcement officer or rescuer.

It is another object of the present invention to provide a rechargeable battery system connected to the handheld device that provides power to the device in a suitable manner, to allow ease of access and portability of such devices.

It is yet another object of the present invention to have built in defensive mechanisms that are operable and easily accessible to the user.

It is yet another object of the present invention to provide a recording mechanism within the device such that the law enforcement or rescuer can capture events seen by the imaging device for later playback.

Another aspect of the present invention is to provide a surveillance system having at least one wireless transmission device for transmitting images from the surveillance system to a remote location.

Another aspect of the present invention is to provide a memory device for storing output from the imaging device including but not limited to USB memory or other removable memory devices.

Another aspect of the present invention is to provide a remote server computer for providing at least one authorized user remote, wireless access to the surveillance system, where the remote server computer and the surveillance system are in wireless digital communication with each other.

Finally, the present invention provides a series of other attachable devices that can be powered by and operated using a rail connect system contained on the handheld unit.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 illustrates a pan view of an exemplary embodiment of the handheld imaging system of the present invention.

FIG. 2 illustrates a rear view of an exemplary embodiment of the handheld imaging system of the present invention.

FIG. 3 illustrates a left side view of an exemplary embodiment of the handheld imaging system of the present invention.

FIG. 4 illustrates a front view of an exemplary embodiment of the handheld imaging system of the present invention.

### DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

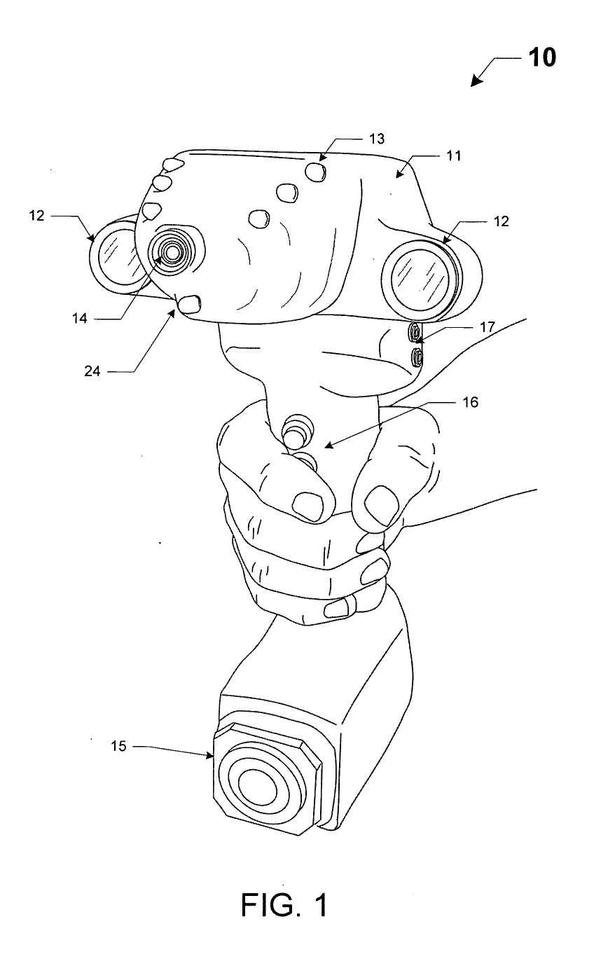

FIGS. 1-4 illustrate the handheld imaging system 10 comprising, a housing 11. The housing 11 comprising, tactical flashlights 12, infrared (IR) lights 13, color camera 14, infrared camera 15, flash strobe switches flash/strobe switches 16, video in/out connectors video in/out connector 17, flashlight switch 18, battery power meter 19, power on/off switch 20, battery recharge port 21, video monitor 22, and video selector switch 23.

More particularly, FIG. 1 illustrates a pan view of the handheld imaging system 10 according to this invention. Handheld imaging system 10 is designed to transmit still or video images generated by color CCD camera 14 or infrared camera 15 to a user holding the device on a small video monitor.

Housing 11 is the main body of handheld imaging system 10. Housing 11 has an upper, middle and lower portion. Housing 11 is specifically designed to have the infrared camera 15 in the lower portion of housing 11. Additionally, housing 11 is specifically designed to have flash/strobe switches 16 in a middle portion of the housing 11. The middle portion also serves as a grip for the handheld imaging system 10. Housing 11 is an object designed to be easily held in the hand of a user to allow for ease of portability and carrying. Additionally, housing 11 provides advantages that will be apparent from the use of the handheld imaging system 10. For example, the video monitor 22 and the infrared camera 15 are positioned some distance away from each other such that. The shape of the housing 11 provides a particular advantage because a law enforcement official may position the infrared camera 15 around a corner to view into a potentially dangerous area using video monitor 22. This allows the official to remain in a safe position while being able to assess a situation. Accordingly, certain components of the handheld imaging system 10 are specifically positioned on housing 11 for advantageous purposes which will be apparent from the embodiments described herein.

In an exemplary embodiment, housing 11 may be composed of a variety of materials, such as metals, plastics, or alloys. This list is not exhaustive, however, and should not be interpreted so as to limit the scope of the present invention. In an exemplary embodiment, the material used in the composition of housing 11 may be rigid so as to maintain a pre-molded shape, but to also be sufficiently lightweight and durable to withstand frequent use. Further, housing 11 may absorb or dampen the force of sudden movement, thereby protecting handheld imaging system 10's interior components for image generation and transmission. Additionally, housing 11 may also be composed of a material able to shield handheld imaging system 10's interior components from damage by heat radiated by an exterior source.

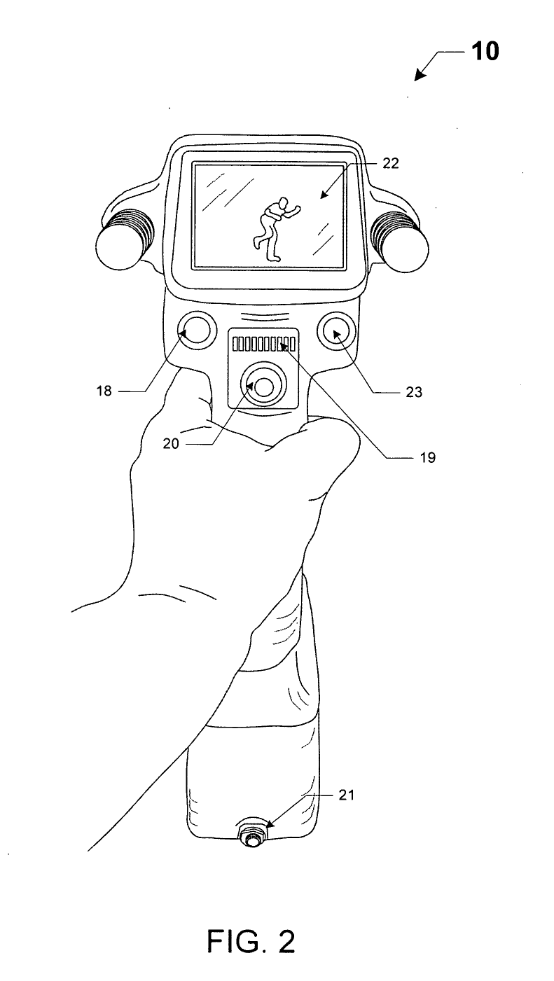

Tactical flashlights 12 are components of handheld imaging system handheld imaging system 10 situated in housing 11. Tactical flashlights 12 are designed to function in a number of different modes. These modes are intended to be programmable using firmware. In this embodiment, a user could press the flashlight switch 18 shown in FIG. 2, to cause handheld imaging system 10 to operate in a first mode as discussed below, and then press flash/strobe switches 16 to cause the handheld imaging system 10 to operate in the second mode as discussed below. Further the user could also press the flash/strobe switches 16 to cause the handheld imaging system 10 to enter into the third mode where the strobe functionality is actuated, as discussed below. The modes available to the user are including but not limited to a first “continuous on” mode operating like that of a traditional flashlight. Here, the light emitted from tactical flashlights 12 is bright enough to illuminate surrounding areas, but not so bright that it would temporarily blind or disable a person looking into it. In a second mode, tactical flashlights 12 are capable of emitting intensely bright light designed to cause eye discomfort to a person or animal in its shine path. In this mode, according to a preferred embodiment, the tactical flashlights 12 would output light that is above the eye comfort level of persons or animals in its shine path, such as above 150 lumens. In a third mode, tactical flashlights 12 can also function in a user programmable strobe mode. In this mode, the tactical flashlights 12 are designed to rapidly cycle in an on/off pattern to produce a strobe lighting effect, while emitting light above the 150 lumen threshold. The strobe component preferably is provided by electronics, incorporating for instance a capacitor or an integrated circuit that can repeatedly cycle power to another component at a specified frequency. The strobe component can provide emergency identification of those under duress or provide disorientation to criminals.

Color CCD camera 14 is a component of handheld imaging system 10 situated within housing 11. Color CCD camera 14 is designed to generate or capture still or moving images which can be used for surveillance and storing of the images. Color CCD camera 14 may be fixed focus, or have auto focus or rangefinder capabilities. In an exemplary embodiment, color CCD camera 14 may function through digital means; however, color CCD camera 14 may capture images through analog technology. Further, while color CCD camera 14 may generate images in color, color CCD camera 14 may generate images in color, black and white, or other types of image output.

The captured images from color CCD camera 14 may be stored on a memory device that is resident in handheld imaging system 10, or be wirelessly transmitted to a remote location using a wireless transmitter, as discussed below with respect to FIG. 5. The wireless transmission of the images can be completed live, as the images are being captured by color CCD camera 14 or they may be stored and later transmitted to a remote location using wireless transmission technologies, such as cellular, or Bluetooth™ methods already known in the art.

Color CCD camera 14 may also contain an ambient light sensor. For example, an ambient light sensor can be utilized to facilitate adjusting the brightness of the video monitor 22. In some implementations, an accelerometer can be utilized to detect movement of the handheld imaging system 10. Accordingly, display objects and/or media can be presented according to a detected orientation, e.g., portrait/landscape or inverted according to the positioning of the handheld imaging system 10.

For images stored on in a memory on handheld imaging system handheld imaging system 10, video in/out connector 17 may be used to connect to an outside video monitor or other display device. The video in/out connector 17 can be one of any combination of S-video input/output connectors, a VGA (Visual Graphics Array) output connector, a DVI (Digital Visual Input) output connector, audio input/output connectors, a USB (Universal Serial Bus) port or any other means for transferring stored images and sound from the handheld imaging system 10 through a physical connection without departing from the scope of this invention.

The tactical flashlights 12 may also serve as a light source for color CCD camera 14 when it is capturing images. When in low light situations, color CCD camera 14 may signal a control component to cause tactical flashlights 12 to turn on and operate as needed.

In an exemplary embodiment, infrared camera 15 is a component of handheld imaging system 10 situated in housing 11. Infrared camera 15 generates images in the infrared portion of the electromagnetic spectrum, which may be useful in situations with low levels of visible light (e.g. night-vision). Infrared (IR) lights 13 emit infrared light for use with infrared camera 15. These images can be displayed on video monitor 22, stored in the memory of handheld imaging system 10 or output using video in/out connector 17

An audio recording component 24, which is part of handheld imaging system 10, may be situated proximate to color CCD camera 14 of housing 11. Audio recording component 24 is designed to record audio feedback received concurrent with the still or moving images recorded by color CCD camera 14 and infrared camera 15 (described in detail below). In one embodiment, audio recording component 24 is a microphone adapted to record audio feedback. In another embodiment, audio recording component 24 may record audio feedback by means of analog or digital recordings without limiting the scope of the present invention.

FIG. 2 depicts a back view of handheld imaging system 10. As discussed above, video monitor 22, is a component of handheld imaging system 10 designed to provide a visual representation of images captured by color CCD camera 14 and infrared camera 15. In an exemplary embodiment of the present invention, video monitor 22 may be securely enclosed within housing 11, and therefore visible to the user. While an exemplary embodiment of the present invention comprises video monitor 22 including a liquid crystal display, the method of display should not be interpreted to limit the scope of the present invention. Video monitor 22 may comprise a liquid crystal display, light emitting diodes, cathode ray tube, liquid crystal on silicon, or other display technology. Additionally, video monitor 22 may include a backlight and provide a visual output in a plurality of colors in the visual spectrum.

Battery power meter 19 is a component of handheld imaging system 10 situated within housing 11. It is operable to display the illuminate the corresponding bars of the battery power meter 19 to indicate the amount of power remaining in the power source contained within housing 11. The power source supplies handheld imaging system 10 with power. The power source may comprise a battery. In an exemplary embodiment, the power source may be rechargeable. In such an embodiment, power source may include battery recharge port 21, or other connection type interface for recharging the power source. In an alternative embodiment, the power source may be removable, such that the power source is removed from handheld imaging system 10 for recharging. In yet another embodiment, the power source may be disposable, such that the power source may be replaced when its charge has been depleted.

Power on/off switch 20 is a component of handheld imaging system 10 to provide on/off functionality to all of the components of handheld imaging system 10. In an exemplary embodiment, power on/off switch 20 may comprise a switch, knob, compressible button, or some other type of component such as to provide the user a means of handheld imaging system 10 on and off. In exemplary usage of 10 activating power on/off switch 20 while 10 is in an off state would turn handheld imaging system 10 on, while activating power on/off switch 20 while handheld imaging system 10 is in an on state would turn handheld imaging system 10 off.

Video selector switch 23 is a component of handheld imaging system 10 such that it serves to select.

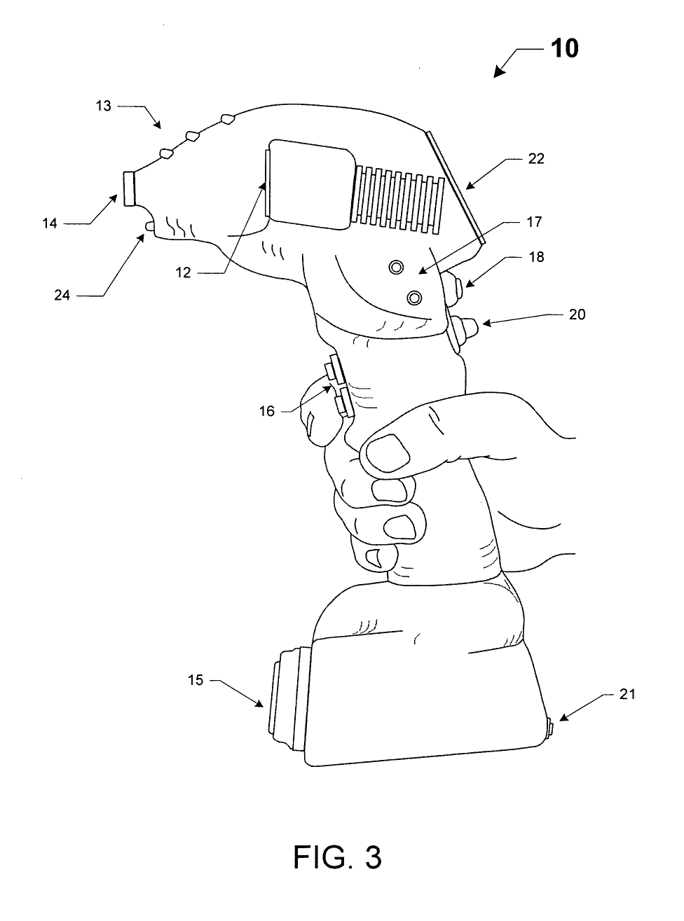

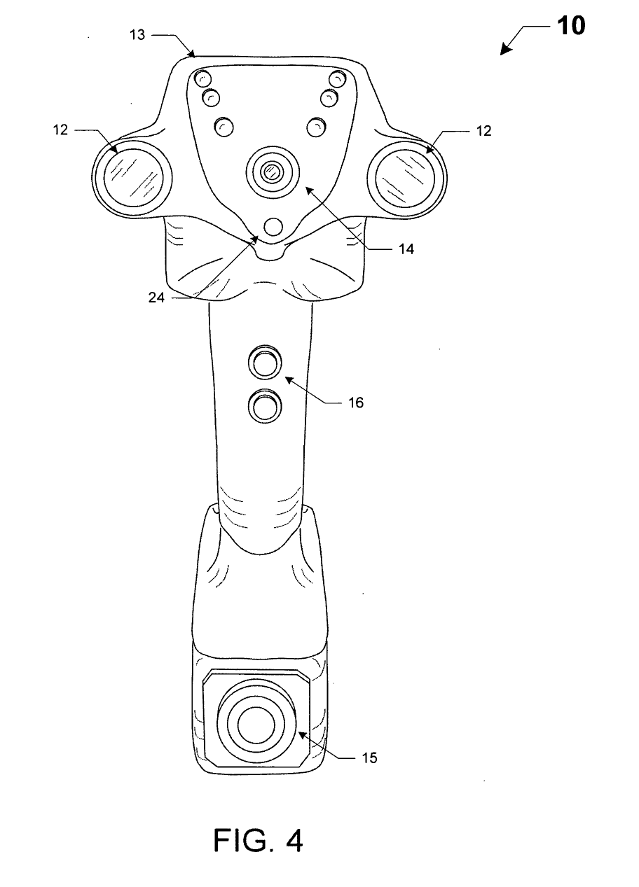

FIGS. 3 and 4 depict handheld imaging system 10 in left side view and a front view. These figures are intended to show the lay out of the components of handheld imaging system 10.

The handheld imaging system 10 can also include other components built into the housing 11. These components are not included in the FIGs due to the These include, but are not limited to sirens/alert devices, GPS tracking, emergency call ability, radios, weather stations, tasers, pepper spray and laser light sources. In those embodiments, the handheld imaging system 10 can include circuitry and/or sensors for supporting a location determining capability, such as that provided by the global positioning system (GPS) or other positioning systems (e.g., systems using Wi-Fi access points, television signals, cellular grids, Uniform Resource Locators (URLs)). Also a positioning system (e.g., a GPS receiver) can be integrated into the housing 11 or provided as a separate device that can be coupled to the handheld imaging system 10 through an interface to provide access to the location-based services.

These additional components can be cycled through using the video selector switch 23 as described above for the video selection function or be made programmable to operate with other functions of the handheld imaging system 10. For example, the siren or alert noise component can be made to operate when the flash/strobe switches 16 are depressed. Accordingly, the siren and the strobe lights will operate simultaneously. The siren or alert noise component preferably includes a speaker capable of producing a loud noise to attract attention to a user of the handheld imaging system 10, to ward off would-be attackers or fleeing suspects and to disorient the attackers or fleeing suspects.

The GPS tracking component, includes a GPS receiving and broadcasting device capable of receiving ones location from Global Positioning Satellites (GPS) and then broadcasting that location over the airwaves or satellite to others such that a user's location could be identified. The emergency call component preferably includes a cellular telephone device or a radio broadcasting device capable of calling others for assistance once activated by a user. The radio preferably includes a receiving antenna and a speaker capable of relaying a radio broadcast to a user. The weather station/notification component preferably includes a display or a speaker to notify a user of weather conditions in the user's vicinity.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term, “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld imaging system comprising:
a housing having an upper portion, a middle portion and a lower portion,
wherein the upper portion contains a color CCD camera, infrared (IR) light, tactical flashlight, video in/out connector, audio recording component, a power on/off switch, flashlight switch, a video monitor, a video selector switch and battery power meter;
wherein the middle portion contains a flash/strobe switch; and
wherein the lower portion contains a infrared camera and a battery recharge port.

2. The handheld imaging system of claim 1, wherein the video selector switch is capable of selecting between image outputs from the color CCD camera and the infrared camera for display on the video monitor.

3. The handheld imaging system of claim 1, wherein the tactical flashlight is capable of operating in multiple modes.

4. The handheld imaging device of claim 3, wherein the modes of operation are selectable using the flash/strobe switch.
